(19) United States
(12) Patent Application Publication
(10) Pub. No.: US 2015/0010605 A1
(43) Pub. Date: Jan. 8, 2015

(54) PROCEDURE FOR MANUFACTURING CERAMIC ARTICLES HAVING ANTIFUNGAL, ANTIBACTERIAL AND ANTIMICROBIAL PROPERTIES, AND CERAMIC ARTICLES

(71) Applicant: Accord Comunicaciones LTDA, Santiago (CL)

(72) Inventor: Maria Jimena Charme Delgado, Santiago (CL)

(21) Appl. No.: 14/380,929

(22) PCT Filed: Jan. 23, 2013
(86) PCT No.: PCT/IB2013/050583

§ 371 Date: Aug. 25, 2014

(30) Foreign Application Priority Data
Feb. 27, 2012 (CL) 201200506

(51) Int. Cl. A01N 59/20; A01N 25/08; C04B 41/50

(52) U.S. Cl. CPC A01N 59/20; C04B 41/5023; A01N 25/08
USPC 424/409; 427/401; 427/331

(57) ABSTRACT

Procedure for manufacturing ceramic articles such as floor and wall tiling as well as sanitary ware having antifungal, antibacterial and antimicrobial properties comprising the molding, drying, baking (firing) and vitreous glazing stages from clays and hydration agents, characterized in that in said vitreous glazing stage is added to the glazed surface, copper particles with spherical shape being in a standardized range from 0.5 to 1.5 millimeters in diameter or cylindrical particles being in a standardized range from 0.5 to 1.5 millimeters in diameter and 0.5 to 1.5 millimeters in length, in a copper ratio on the ceramic article surface between 1 milligram per weight to 10 milligram per cm² of the ceramic surface.

### TECHNICAL FIELD OF THE INVENTION

The present invention relates to a process for manufacturing ceramic products for sanitary ware containing copper which have antifungal, antibacterial and antimicrobial properties. The present invention more specifically relates to a process for manufacturing ceramic products coated by vitro fused glaze to which at a stage of the process is added copper particles within a range of 0.5 to 1.5 mm in diameter wherein the products acquire anti-fungal, anti-bacterial and anti-microbial properties, derived from the presence of copper and copper oxide on the glazed surface comprising the glaze.

### BACKGROUND OF THE INVENTION

The ceramic products with anti-fungal, anti-bacterial and anti-microbial properties and to which copper is added are well known in the state of the art. However, the difficulty in applying the copper has resulted in that the manufacture of this kind of products has not been massive in the market. There are several processes to manufacture ceramic products incorporating copper. For instance, document CN 1458128 discloses a method for producing antibacterial ceramics wherein the baked ceramic material is submerged in a copper salt, zinc salt, silver salt or molten magnesium salt so as the metallic ion can penetrate or enter the ceramic glaze layer by means of self-diffusion or mutual diffusion.

Document EP 1952692 Method for the production of an antibacterial or antimicrobial ceramic material which is based on the provision of a porous ceramic support material in and/or on which silver, copper and/or zinc ions are stored, which involves bonding the metal ions with by solid phase ion exchange in a dry phase.

Document JP 8290985 discloses a process for manufacturing an antimicrobial ceramic product having an excellent heat resistance. The antimicrobial ceramic product is obtained by means of the formation of a metal layer comprising silver, copper, cadmium, zinc, nickel, gold, platinum, rhodium, bismuth, chromium or Indium on the surface of a baked and ceramic product base. The metal layer preferably contains 1-99 wt % Ag. The metal layer preferably contains a glass component. The ceramic product base, for instance, is a porcelain or glazed glass. The ceramic product base is a food container, a sanitary tool or a glazed tile.

Document U.S. Pat. No. 5,618,762 discloses an antibacterial ceramic containing an antibacterial material produced by loading an antibacterial metal such as silver on a calcium ceramic carrier and an inorganic material such as cordierite, and has a bulk density of 0.6-1.2 g/cm.sup.3. An antibacterial ceramic filter contains an antibacterial material produced by loading an antibacterial metal such as silver on a calcium ceramic carrier, an aggregate such as mullite, and a binder such as frit, and has a porosity of 20% or more. The light-weight antibacterial ceramic is suitably applicable to a roof garden or the like. The antibacterial ceramic filter can remove and extirpate various bacteria and suspensions.

Document U.S. Pat. No. 5,151,122 discloses a process for producing an antibacterial ceramic material wherein at least one ceramic selected from the group consisting of hydroxyapatite, calcium phosphate, calcium hydrogen phosphate, calcium carbonate, calcium silicate and zeolite is made to absorb and tightly retain at least one liquefied metal salt selected from the group consisting of salts of silver, copper and zinc, after which heat firing at elevated temperatures is performed.

None of the documents of the state of the art discloses a process for manufacturing ceramic products which are coated with a vitro-fused glass to which copper particles within a range of 0.5 to 1.5 mm in diameter are added and wherein the products acquire anti-fungal, anti-bacterial and anti-microbial properties.

### SUMMARY OF THE INVENTION

The ceramic products elaborated according to the procedure of the present invention are coated with vitro fused glaze to which during the glazing process are added copper particles having a diameter within a range of 0.5 to 1.5 being distributed on the surface with a ratio of 1 mg weight to 10 mg per cm² of the ceramic surface.

The ceramic products with the characteristics of this invention have a wide application in the floor and wall tiling which when being manufactured with the product of this invention they prevent a wide variety of fungi, bacteria and harmful microbes to human health from existing and reproducing. In the case of ceramic tiling (in some markets they are referred to as tin-glazed ceramic tiles) that are used in facilities which required or privilege antifungal and antimicrobial characteristics such as clinical laboratories, clinics, hospitals and all the facilities aimed to health assistance, constitute a great contribution in decreasing the so called in hospital infections.

In the case of products such as sanitary ware, particularly, toilet bowls, washbasins, bidets, and bathtubs, the ceramic products treated by means of the procedure described in this specification guarantee a greater asepsis state to be used in the construction or remodeling of public restrooms and home bathrooms.

The antifungal and antimicrobial ceramic products, especially the tile (ceramic tiling) also have a wide application in the food industry in all its numerous ways: industrial kitchens in restaurants and kitchens in institutions and industries of massive feeding, treatment of packaged foods, storage of vegetables products, conservation and packaging of foods to be exported (the presence of copper in the handling of foods can be toxic in certain cases, therefore the direct contact of the product with food products is not advisable).

As for the format of floor and wall ceramic tiling, the dimensions, shapes and designs thereof are adapted to the ones used by the various models of the global industry being these with regard to its dimensions, mosaic type ceramic tiles from the smallest ones to the ones of bigger size covering a wide range of sizes. In the same way, it is applied to sanitary ware in its varied spectrum of designs and sizes.

### DESCRIPTION OF THE TECHNICAL PROBLEM TO BE SOLVED

The ceramic products after being subject to the baking and drying processes present a rough and porous superficial finish which absorbs humidity and wherein the roughness thereof makes difficult its cleaning. Due to the aforementioned, it becomes necessary to apply a subsequent treatment called glazing which consists in the application of silica in aqueous suspension on the ceramic product surface as a layer of paint, manually in the case of handmade products or by means of industrial spray guns or any other methods for mass production products.

After the drying process of this silica layer the piece is again subject to a baking process in order to fuse this glaze layer on the raw ceramic of the piece being treated. This results in a thin layer of glass tightly attached to the surface due to the subjacent porosity of the ceramic, thus obtaining an easy-to clean product because of the smoothness of the surface, being waterproof and having a good aesthetic presentation.

The objective of the present invention is providing a process for manufacturing ceramic products: tiles, ceramics, sanitary ware such as toilet bowls, washbasins, bidets, and bathtubs having antifungal and antimicrobial properties by means of the application of copper during the glazing stage.

During the last years, studies about antimicrobial, antifungal and antibacterial efficiency on different contact surfaces have clearly shown that copper and other copper alloys inhibit the widest range of the most powerful and resistant types of microbes, bacteria, fungi and moulds which play a significant role in the decay of food products and in the pollution of closed environments, built for food processing or conservation purposes, for treatments of human or animal health and many other applications which require an important state of asepsis.

On the other hand, is by general rule, at a global level, the use of fixtures and floor and wall tiling manufactured of glazed ceramic materials, since there is not a better alternative due to its aesthetic beauty, durability, mechanical, ease of cleaning and hygiene characteristics also being a field in which are everyday appearing innovative ways of application and production.

Due to the aforementioned, the problem which the present invention deals with is the way of adding copper to ceramic products by means of a low-cost process which allows attaching copper particles during the glazing stage preventing the particles from totally oxidizing during the baking stage and wherein the particles cannot be detached from the glazed surface by mechanical detachment.

To that end, the present invention incorporates within the glazing process copper particles wherein the diameter thereof is about 0.5 to 1.5 millimeters, in such a way that when spreading it on the surface of the ceramic product, the latter gets impregnated with said particles. Then, during the glass fusing the glaze reaches 960° C., it gets liquefied which results in that the copper particles are partially submerged into the glaze. Once the glaze is cooled, the submerged section of the particle remains trapped on the vitrified surface and at the same time one portion remains exposed to the exterior. Due to the aforementioned, the ceramic product acquires antifungal, antibacterial and antimicrobial properties.

### STATE OF THE ART OF THE CERAMIC MANUFACTURING PROCESS

The ceramic manufacturing process is developed in a series of successive stages which can be summarized as follows:
Preparation of raw materials
Shaping and drying of the raw piece
One or more firing stages with or without glazing stage
Additional Treatments

### Preparation of Raw Materials

The ceramic process begins by selecting the raw materials which must be part of the composition of the paste, essentially clays, feldspars, sands, carbonates and kaolins.

In the traditional ceramic industry, generally, raw materials are used in the same way as they are extracted from the mine or quarry or after subjecting them to minor treatment. Due to its natural origin, in most cases, a previous homogenization is required which guarantees the continuity of its characteristics.

### Wet or Dry Grinding

Once made the first mixture of the different components of the ceramic paste, this is, generally subject to a grinding or milling process which can be made in dry (hammer or pendular mills) or in wet (continuous or discontinuous ball mills).

The resulting material presents different characteristics if said grinding is carried out in dry or in wet. In the first case, a fragmentation occurs wherein both particle aggregation as well as particle agglomeration are maintained, being the size of the resulting particles (particles of a greater size about 300 μm) greater than the one obtained in wet (particles of a smaller size about 200 μm). The kind of grinding to be used constitutes a decisive factor in the required investment cost.

### Wet Grinding and Spray Drying of the Composition

The procedure that has been totally imposed in the manufacture of ceramics, due to the significant improvements with regard to the techniques thereof is carrying out the process in wet and the subsequent drying of the resulting suspension by spraying.

In the wet procedure, the raw materials can be totally or partially introduced in the ball mill which is the normal way, or can directly be dissolved when the grinding stage is not required.

A water portion being contained in the resulting suspension (slip) is eliminated until reaching the humidity content necessary for each process. The most used method is spraying drying.

The spray process is a drying process by means of which a suspension sprayed in thin droplets, enters into contact with hot air to produce a solid product of a low water content.

The humidity content existing in the suspension (slip) normally is about 0.30-0.45 kg of water by kg of dry solid. This water content after being subject to the spraying process is reduced to 0.05-0.07 kg of water per kg of dry solid.

The spray drying process is developed according to the following stages:
Pumping and spraying the suspension
Generation and feeding hot gases.
Suspension droplet-hot gas contact drying
Separating the sprayed powder from the gases.

The sprayers operate following the next sequence:

1) The slip coming from the storage basins of the grinding plants having a solid content between 60 and 70% and with an appropriate viscosity is pumped to the spraying system of the slip.

2) The slip finely nebulized and divided is dried by putting it into contact with a hot gas current. These gases come from a natural gas-air conventional burner or other generation source.

3) The granulated material having a humidity between 5.5 and 7% is unloaded on a conveyor belt and carried to the silos for its subsequent pressing. The gas current used to dry the slip and thus obtaining the spray dried powder is eliminated by the upper part of the sprayer containing a high level of humidity and very thin powder particles in suspension.

The spray drying process to obtain the raw material for the body (spray dried powder) favors the development of the subsequent manufacturing process stages due to the obtaining of granules having a more less spherical shape, hollow on the inside and being very uniform, which provides the spray dried powder with a high fluidity, making easier the filling of molds as well as the pressing of pieces.

In this process are carried out two operations at once which are the drying and granulation and by means of the same equipment. The control of variables presents a great simplicity and due to its continuous nature it makes its automation easier.

The energy cost of this drying process is very high, however it is possible to increase the profitability of the same by means of the utilization of the heat of the gases coming from the electricity generation by means of the use of cogeneration turbines.

### Kneading

The kneading process consists in thoroughly mix water and raw materials of the composition of the paste, which results in a easily shapeable plastic dough.

### Shaping of the Pieces

### Dry Pressing

The main shaping process of the pieces is the dry pressing (5 to 7% humidity) by means of the use of hydraulic presses This shaping procedure operates by a mechanical compression of the paste in the mold and is one of the most cheapest procedures to manufacture ceramic products having a regular geometry.

### Extrusion

Basically the shaping procedure of pieces by extrusion comprises to make them go through a paste column in a plastic state through a matrix which forms a constant section piece.

The equipment used comprise three main parts: The drive system, the matrix and the cutting device. The most common drive system is the propeller system.

### Drying of Shaped Pieces

The ceramic piece once shaped is subject to a drying stage in order to reduce its humidity content until reaching low enough levels (0.2-0-5%) so as to carry out the firing and glazing stages in the proper way.

The drying of the pieces is carried out in vertical or horizontal dryers. After the shaping, the pieces are introduced in the dryer where they are put into contact, in opposite direction, with hot gases. The main heat transfer mechanism between air and the pieces is the one by convection. The air to be used must be dry and hot enough to eliminate the water coming from the solid and also to provide energy in the way of heat, required by the water to evaporate.

In the vertical dryers, the pieces are placed in metal structures thereby forming among several metal structures the units which are normally referred to as “baskets” (cestones). The group of metal baskets is vertically moved inside of the dryer wherein the basket-piece combination enters into contact with hot gases.

Normally, the temperature in this kind of dryers is lower than 200° C. and the drying cycles are generally between 35 and 50 minutes.

In horizontal dryers, the pieces are introduced in varied metal structures and they are horizontally moved inside of it by means of rolls. The hot air that enters into contact in a countercurrent configuration with the pieces, is provided by the burners located on the sides of the kiln. The maximum temperature in this kind of installations normally is higher than in the case of vertical dryers (about 350° C.) and the drying cycles are shorter, about 15 to 25 minutes.

Generally, horizontal dryers have a lower energy consumption with regard to the vertical ones due to the better arrangement of the pieces in its interior.

### Firing Stage

On the shaped products, after carrying out the drying stage, takes place the firing of the piece, glazed or non-glazed according to the technology (single and double firing). By means of this operation, the ceramic piece is provided with its final properties being these size and mechanical resistance.

In this process the relevant variables are:
The thermal cycle, which is characterized by the maximum temperature of the kiln, residence time at that temperature and the heating and cooling speeds.
The more less oxidizing atmosphere inside the kiln.
The kiln, position of the upper and lower burners.
The different reactions occurring inside the kiln, organic matter decomposition, carbonates, clayey minerals, formation of new phases.
Thermal shocks of the pieces during the cooling.
Adhesion between the glazing and the body.

Throughout the firing cycle are the following stages:
Slow preheating
Fast preheating
Firing Stage
Slow cooling and
Fast cooling.

During the initial preheating stages and final cooling stages about 570° C., quartz suffers a change in its structure in the allotropic way from α to β, which results in a change in size which when being carried out in the inappropriate way, causes a breakage of the ceramic piece (dunt, due to the quartz).

The physical-chemical transformations developed during the firing stage are:
Chemical changes:

Dehydrations: 2SiO₂.Al₂O₃.2H₂O→2SiO₂.Al2O₃+2H₂O

Decompositions: CaCO₃→CaO+CO₂

Combustions: CnHm→+H₂O

Crystallizations: 2SiO₂+3Al₂O₃→3 Al₂O₃.2SiO₂

Physical changes:
Dimensional changes
Fusions
Allotropic changes (α-SiO₂→β-SiO₂ and vice versa).

### Different Firing Techniques

There are different technologies or procedures for firing ceramic pieces as the case may be:

a) A first firing stage of the biscuit without the vitreous layer followed by a subsequent firing stage at a lower temperature for the fired body+vitreous layer combination.

b) A sole firing for the fired body +vitreous layer combination.

Also depending on the temperature being worked with and the kind of biscuit being used it is possible to distinguish:
Traditional double firing: Using tunnel-kilns with cycles of 23-26 hours and maximum working temperatures of 900° C.
Double Fast Firing: Cycles of 30-55 minutes and maximum temperatures of 1000-1060° C.
Porous single Firing: Body enriched with carbonates, cycles of 35-55 minutes and maximum temperature of 1080-1150° C.
Single-fired stoneware: Body poor in carbonates, cycles of 35-55 minutes and maximum temperatures of 1100-1180° C.
Single fired porcelain stoneware: Material very poor in carbonates, very white and more refractory, cycles of 45-60 minutes and maximum temperature 1180-1230° C.

Another existing difference in each production technology (except the porcelain stoneware which is unique) is the kind of paste being used to work. There are two very well defined types of paste and which differ in the type of clay used in its formulation, thus we have red paste (comprises red clays enriched with iron oxides) and white paste (comprises white, refractory and poor in iron oxides clays).

Generally the white paste has been associated with better quality materials due to the colors (since when having a light-colored base it allows a wider and lighter range of superficial colors) and technical characteristics (since when being more refractory they need higher temperatures which results in a subsequent better stability and vitrification.

### Glazing

The glazing consists of applying one or many vitreous layers using different methods having a thickness comprised between 75-500 μm in total which covers the surface of the piece. This treatment is carried out to provide the fired product with a series of technical and aesthetic characteristics such as: waterproof qualities, ease of cleaning, gloss, color, superficial texture and mechanical and chemical resistance.

The nature of the resulting layer is essentially a glass-like layer even though it includes in many occasions, crystalline elements in its structure.

### Glazing and Frits

The tin glazing as well as the ceramic paste comprises a series of inorganic raw materials. The major glaze component is silica (glass former) as well as other elements acting as fluxes (alkalis, alkaline earth metals, boron, zinc, etc) as opacifiers (zirconium, titanium, etc.) as coloring agents (iron, chromium, cobalt, manganese, etc).

Depending on the type of product, on its firing temperature and on the effects and properties to be achieved in the finished product, a wide variety of glazing types are formulated.

In other ceramic processes (artistic porcelain, sanitary ware) are used exclusively and solely crystalline, natural or synthetic raw materials in the formulation of tin glazing which provide the necessary oxides. In turn, in the ceramic tiling process are used raw materials of glass-like nature (frits) prepared from the same crystalline materials previously subject to a high temperature thermal treatment.

### Frits: Nature, Advantages, Composition and Manufacture

Frits are glass-like components, water insoluble obtained by fusion at a high temperature (1500° C.) and subsequent fast cooling of predetermined mixtures of raw materials (the term Frit comes from the sound similar to the sound of fried food that makes the fused material when in contact with cold water).

The majority of glazes used in the industrial manufacture of ceramic tilings have a fritted part to a greater or lesser proportion in its composition, wherein in some cases could be one sole frit or mixtures of different types of frits.

The use of frits presents the following advantages in contrast with the use of non-fritted raw materials for a given chemical composition:
Insolubilization of some chemical elements
Decrease of the toxicity, the obtained vitreous material due to its size and structure has less tendency to the formation of environmental powder than raw materials where it comes from, decreasing thereby the danger associated with its toxicity.
Widening of the temperatures interval of the glaze work since there are no defined fusion points.
The frit manufacture process generally called fritting has as an objective the obtaining of a vitreous non-soluble in water material by means of fusion and subsequent cooling of the mixtures comprising different materials.

The process begins with a dosage of the previously selected raw materials and which have been controlled in the established proportion. By means of pneumatic transportation the different types of raw materials are moved to a mixer.

There is a great variety of fritted ceramics which differ in their chemical composition and in the physical characteristics related to it. The components that are soluble or toxic by themselves are always provided in a fritted way to considerably reduce its solubility, as occurs with lead, boron, alkalis and some other minor elements. The rest of the components can be used in fritted form or as crystalline raw material depending on the desired effect.

Frits can be classified according to a variety of criteria: according to its chemical composition (plumbic, boracic, etc.), according to its physical characteristics (opaque, transparent, etc.) depending on its fusion interval (melting, hard), etc.

Currently a series of frits aimed to determined production processes has been developed which encompass several of the desired characteristics and which makes even harder the classification of ceramic frits.

The raw materials mixture is conveyed to a hopper from which it enters the kiln wherein the fritting itself takes place The kiln feeding is carried out by means of an auger, whose speed controls raw materials mass flow fed into the kiln. The material's residence time inside the kiln is defined by the raw materials melting rate and melt flowability.

The kiln is provided with natural gas burners using air or oxygen as a comburent. These systems allow reaching temperatures about 1400-1600° C. which are necessary to carry out this kind of process.

The fritting process can be run non-stop with continuous kilns followed by cooling in water or air-cooling, or in rotary batch kilns followed by cooling in water.

Continuous kilns have a tilted base to facilitate the descent of the molten mass. An overflow is fitted at the outlet, together with a burner that acts directly on the viscous frit melt thus preventing its sudden cooling on contact with the air, facilitating continuous emptying of the kiln.

The cooling process can be carried out with water.

The molten material falls directly into the water which causes its immediate cooling. At the same time, the resulting thermal shock makes the glass shatter into small irregular fragments. These are usually extracted from the water by means of an auger, subsequently conveying them to a dryer to eliminate the humidity caused by the previous treatment.

The cooling process can be carried out with air.

In this case, the molten mass is drawn between two cylinders, fitted with internal air cooling, producing a very fragile sheet that breaks up readily into small flakes.

The intermittent process is carried out to produce frits for which there is less demand. In this case the materials are melted in a rotatory kiln and normally the cooling of the frits is made with water these being the only differences with regard to the continuous process.

The rotary kiln consists of a steel cylinder lined with refractory material provided with an agitation system which allows to homogenize the molten mass.

### Glazes: Preparation and Application.

The glazes preparation process normally consists of subjecting the frit together with additives to a grinding phase until obtaining a prefixed granulometry. The conditions of the aqueous suspension are then adjusted. Suspension characteristics will depend on the application method to be used.

The glazing of ceramic pieces during the industrial processes is generally carried out in a continuous way and the most common application methods are waterfall glazing or spraying.

### Firing of Pieces

The firing of ceramic products is one of the most important stages of the manufacturing process since most of the ceramic product characteristics depend on it: mechanical resistance, dimensional stability, chemical agents resistance, ease of cleaning, fire resistance, etc.

The main variables to be considered in the firing stage are, the thermal cycle (temperature and time), the kiln atmosphere which must be adapted to each manufacturing composition and technology depending on the ceramic product that is desired to obtain.

The tin-glazed ceramic tile, floor tile for floor and wall tiling and sanitary ware are subject to an initial firing at an industrial standardized temperature depending on the material, above 1100 degrees which allows clay or feldspar to eliminate water, inorganic materials and has been turned into silicates.

By means of the heat input a physical-chemical transformations process is produced which modifies the chemical and crystalline structure of clays in an irreversible way, acquiring stony consistence thus finally obtaining the ceramic products without coating.

The ceramic fixture is in condition of receiving the application of the glaze.

### DESCRIPTION OF THE INVENTION

### Glazing Stage

On the ceramic product surface to which the glazing or silica in aqueous suspension will be applied, are added copper particles.

The dimensions of the used copper particles with spherical shape are within a standardized range from 0.5 to 1.5 millimeters in diameter and the ones of cylindrical shape having a diameter of 0.5 to 1.5 millimeters and from 0.5 to 1.5 millimeters in length. The copper ratio on the ceramic product surface is between 1 milligram per weight to 10 milligram per cm² of the ceramic surface.

Considering that the glaze maintains bitumen properties before being solidified in a natural way at ambient temperature, when depositing the copper particles the latter remain incorporated into the glazed surface.

Spherical copper particles are preferred however also the copper chips obtained from the copper wire which when being cut are transformed into cylinders having a diameter of 0.5 to 1.5 millimeters and a length of 0.5 to 1.5 millimeters. These two shapes of copper particles, both the spherical and cylindrical ones do not have edges or sharp edges which when being exposed to heat are carbonized in a much easier way. In turn, the smooth and rounded surfaces are oxidized in a more uniform way and they do not get carbonized. Also, from an industrial point of view, the feeder required to apply the particles on the ceramic surface works better if the particles are spherical or cylindrical because they flow with ease and have less probabilities of jamming the feeding mechanism. This feeder must be able to provide only one particle per square centimeter, ideally, which represents certain complexity for the design.

On the previously described conditions, the ceramic piece with the glaze together with the attached copper is subject to a baking stage wherein the glaze melts when reaching temperatures of 960 degrees (vitrofusion process). The necessary firing time depends on the size of the kiln and on the ceramic load being contained by said kiln. As a way of reference, a flat piece of 250 cm² needs 5 minutes of exposure to heat.

During the vitrofusion process, the glaze gets liquefied when reaching 960 degrees which makes the copper particle to partially submerged on the glaze. Once the glaze is cooled, the submerged section of the particle remains trapped on the vitrified surface and at the same time one portion remains exposed to the exterior.

Once the ceramic piece has been cooled it is subject to a polishing process to eliminate the protruding parts of cooper and to leave the surface flat and smooth having the common characteristics of ceramic products with vitrofused glaze.

The obtained final product has a glaze color like aspect used with dark spots which show the exposure of copper to environment and which provide the ceramic piece with antifungal and antimicrobial properties.

The use of copper particles of the previously specified dimensions is relevant for being the one better behaved regarding the promotion of glaze-copper combination allowing a better attachment, oxidation degree and aesthetic aspect.

### Laboratory Essays for Determining the Particle Size

Four vitrification tests were performed on ceramic, using as a variable the type of particle and the way in which metal copper is attached. The vitrification process was performed at 1000° C.

| Essay | Copper Type | Cu presence | Oxide Presence | Adhesion |
|---|---|---|---|---|
| 1 | Thin powder | Yes | Yes | Low |
| | 01-03 mm | | | |
| 2 | Coarse powder | Yes | No | High |
| | 0.5-1.5 | | | |
| 3 | Coarse powder | Yes | Yes | Medium |
| | 2-3 mm | | | |
| 4 | Coarse powder | No | Yes | High |
| | 2-3 mm | | | |

From the previously performed essay it is obtained that the best value to support the vitrification baking process and having a high adhesion to the ceramic surface are the cylindrical copper particles of 0.5 to 1.5 millimeters in diameter and of spherical shape of 0.5 to 1.5 millimeters in diameter and 0.5 to 1.5 millimeters in length.

### Laboratory Assays for Determining the Bactericide Efficiency

The evaluated samples correspond to two types of floor tiles; white floor tiles with copper and white floor tiles without copper.

For this activity an inoculum was added to the floor tile and it was incubated for 24 hours at 25° C. Subsequently, the inoculated side of the floor tile is place on a solid culture medium so as to leave an “image” of the inoculum on the agar which will be incubated at 35° C. by 24 hours.

Preliminary results of the essays are shown in the following table:

| | Escherichia coli |
|---|---|
| Sample | Growth (%) |
| White floor tile without spots (Control) | 100 |
| White floor tile with copper (1) | 24 |
| White floor tile with copper (2) | 28 |
| White floor tile with copper (3) | 23 |

The obtained results suggest that ceramic tiles treated with copper reduce the bacterial proliferation in approximately a 70%.

1. Procedure for manufacturing ceramic articles such as floor and wall tiling as well as sanitary ware having antifungal, antibacterial and antimicrobial properties comprising the molding, drying, baking (firing) and vitreous glazing stages from clays and hydration agents CHARACTERIZED in that in said vitreous glazing stage is added to the glazed surface, copper particles with spherical shape being in a standardized range from 0.5 to 1.5 millimeters in diameter or cylindrical particles being in a standardized range from 0.5 to 1.5 millimeters in diameter and 0.5 to 1.5 millimeters in length, in a copper ratio on the ceramic article surface between 1 milligram to 10 milligram in weight per cm² of the ceramic surface.

2. The Procedure according to claim 1 CHARACTERIZED in that it also comprises a polishing stage of the ceramic fixture surface.

3. A ceramic article such as ceramic tiles and sanitary ware having antifungal and antimicrobial properties manufactured by applying the procedure described in claim 1 CHARACTERIZED in that its surface has spherical shaped copper particles which are within a standardized range from 0.5 to 1.5 millimeters in diameter o in a cylindrical shape which are within a standardized range from 0.5 to 1.5 millimeter in diameter and from 0.5 to 1.5 millimeters in length wherein the copper ratio on the ceramic article surface is within a range of 1 milligram per weight to 10 milligram per cm² of the ceramic surface.
